(19) United States
(12) Patent Application Publication
(10) Pub. No.: US 2016/0350998 A1
(43) Pub. Date: Dec. 1, 2016

(54) STACKABLE TRAY APPARATUS FOR HOLDING ARTICLES UPRIGHT

(71) Applicant: Linette Krook, Grand Rapids, MN (US)

(72) Inventor: Linette Krook, Grand Rapids, MN (US)

(21) Appl. No.: 14/722,227

(22) Filed: May 27, 2015

(51) Int. Cl. G07D 11/00

(52) U.S. Cl. CPC G07D 11/0006

(57) ABSTRACT

A stackable tray apparatus for receiving a holding in an upright position a plurality of banded stacks of banknotes. The stackable tray apparatus comprises a base tray defining a rectangular tray housing sized to receive banded stacks of banknotes that includes an integrated follower block. The base tray additionally includes handles extending from opposing ends and an interlock member which, in addition to facilitating the handling of the stackable tray apparatus, provide a structural aspect that improves the stability of stacked base trays. In one embodiment, the follower block is positioned in the receptacle area of the base tray and includes a spring loading assembly that biases it so that it exerts pressure in an holding direction that keeps banded stacks in an upright position in the base tray.

### BACKGROUND OF THE INVENTION

Field of the Invention

This invention relates generally to currency receptacles and, more particularly, to a stackable tray apparatus for holding articles, such as bundled banknotes, upright.

Description of the Prior Art

It is well known that banks and financial institutions are often required to store large quantities of currency bills (or “banknotes”). As such, it is common for banks in the United States to store piles of banknotes that have been sorted by denomination and banded together at an identifiable value in their vaults. A problem which still exists, however, is that such a storage system is often inefficient because if a stack is disturbed sufficiently to break its band, or if the band otherwise becomes broken, bank personnel generally required to re-count the individual bills and apply another band. While metal trays for receiving banded stacks of banknotes exist, they are often very heavy and are not suitable to place in vertical stacks. Thus, there remains a need for a stackable tray apparatus which is suited to receive banded stacks of banknotes and hold them in an upright position. It would be helpful if such a stackable tray apparatus included a interlock member which secures stacked trays in a vertical orientation. It would be additionally desirable for such a stackable tray apparatus to include opposing handles for easing the handling of the trays when it is desired to move them.

The Applicant's invention described herein provides for a stackable tray apparatus adapted to receive and hold a plurality of banded stacks of banknotes in an upright position. The primary components in Applicant's stackable tray apparatus are a base tray and a follower block. When in operation, the stackable tray apparatus enables more effective and efficient storage of banded stacks of banknotes. As a result, many of the limitations imposed by prior art structures are removed.

### SUMMARY OF THE INVENTION

A stackable tray apparatus for receiving a holding in an upright position a plurality of banded stacks of banknotes. The stackable tray apparatus comprises a base tray defining a rectangular tray housing sized to receive banded stacks of banknotes that includes an integrated follower block. The base tray additionally includes handles extending from opposing ends and an interlock member which, in addition to facilitating the handling of the stackable tray apparatus, provide a structural aspect that improves the stability of stacked base trays. In one embodiment, the follower block is positioned in the receptacle area of the base tray and includes a spring loading assembly that biases it so that it exerts pressure in an holding direction that keeps banded stacks in an upright position in the base tray.

It is an object of this invention to provide a stackable tray apparatus suited to receive banded stacks of banknotes and hold them in an upright position.

It is another object of this invention to provide a stackable tray apparatus that includes a interlock member which secures stacked trays in a vertical orientation.

It is yet another object of this invention to provide a stackable tray apparatus that includes opposing handles for easing the handling of the trays when it is desired to move them.

These and other objects will be apparent to one of skill in the art.

### BRIEF DESCRIPTION OF THE DRAWINGS

FIG. 1 is a side perspective view of a stackable tray apparatus built in accordance with the present invention.

FIG. 2 is a top plan view of a stackable tray apparatus built in accordance with the present invention.

FIG. 3 is a bottom perspective view of a stacked stackable tray apparatus built in accordance with the present invention.

FIG. 4 is a front elevational view of a plurality of stacked stackable tray apparatus built in accordance with the present invention.

### DETAILED DESCRIPTION OF THE INVENTION

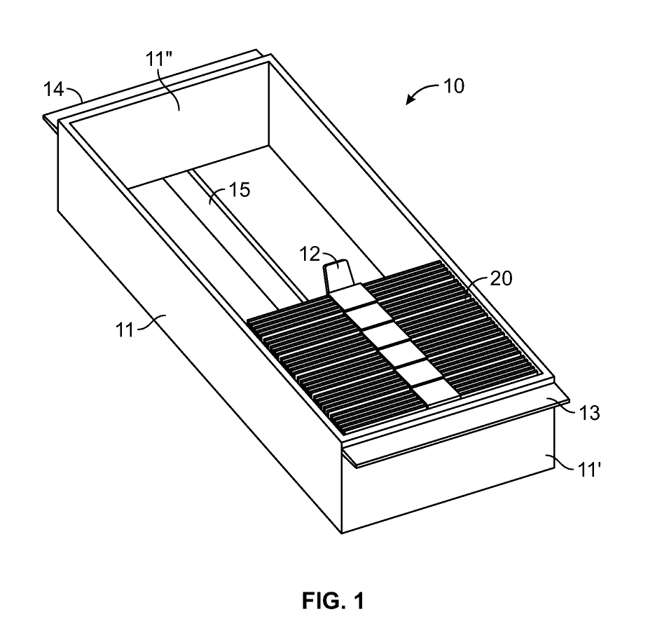

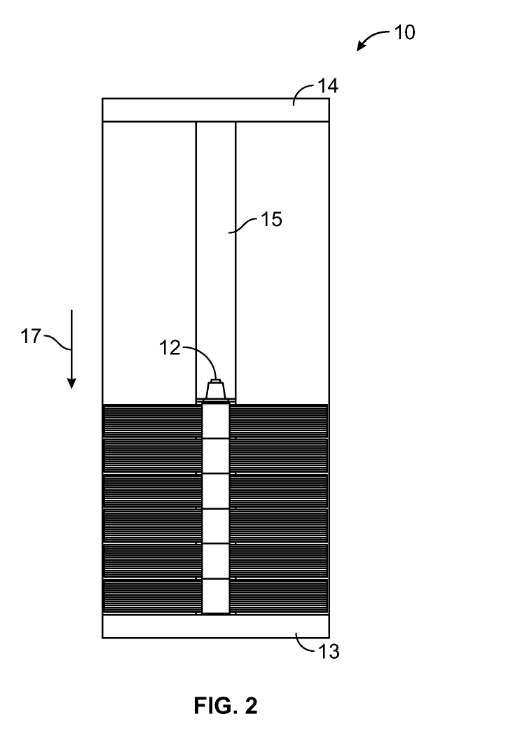

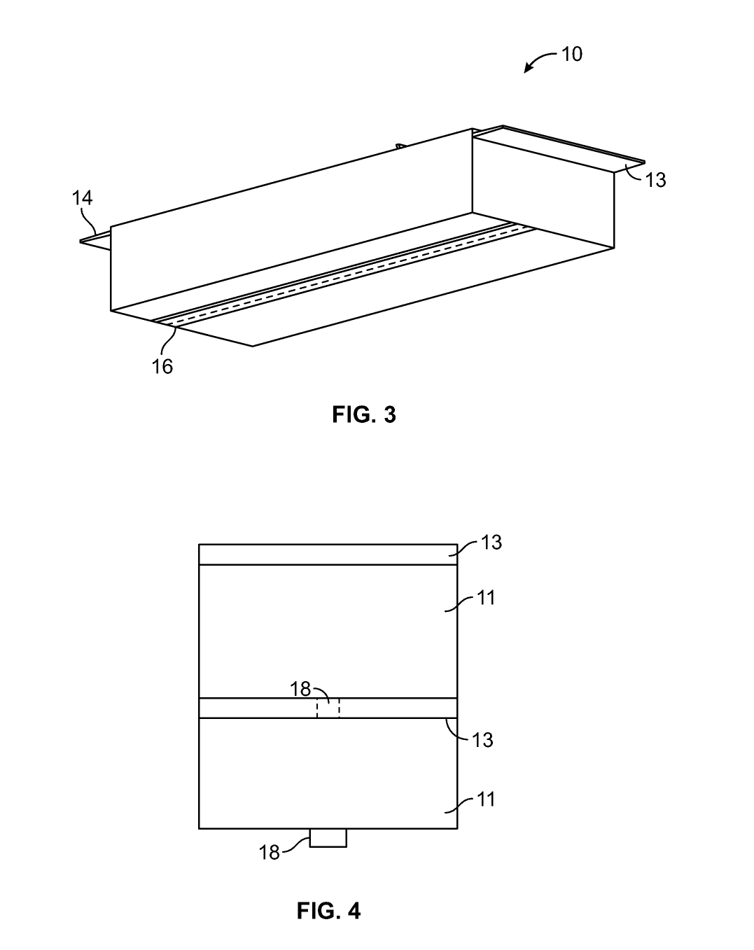

Referring now to the drawings and in particular FIGS. 1, 2, 3, and 4, a stackable tray apparatus 10 is shown having a base tray 11 with an integrated follower block 12. The base tray 11 defines a rectangular tray housing sized to receive banded stacks of banknotes 20. The base tray 11 includes a front handle 13 extending from its front facing 11′ and a back handle 14 extending from its back facing 11″. The follower block 12 is positioned in the receptacle area of the base tray 11, mounted in a block channel 15 that defines an indentation along the length of the floor of the base tray 11. From underneath the base tray 11, the indentation that defines the block channel 15 defines an interlock member 16.

The interlock member 16 is positioned such that if a first base tray 11 was aligned with and placed on top of a second base tray 11, the interlock member 16 on the first base tray 11 would wedge between the front facing 11′ and back facing 11″ of the second base tray 11, thereby forming an interlock for holding the first base tray 11 secure on top of the second base tray 11. Accordingly, the front facing 11′ and back facing 11″ of a lower base tray and the interlock member 16 of a upper base tray define an interlocking system that is operative to secure stacked trays together.

In the preferred embodiment, the base tray is 15″×7″×3¼″ and is constructed out of acrylic or a rigid, heavy duty plastic.

In one embodiment, a spring loading assembly (not shown) is included in the block channel that biases the follower block 12 such that it exerts pressure in an holding direction 17, thereby enabling it to hold banknotes 20 that have been placed against the front facing 11′ in an upright position against the front facing 11′ in the upright position. It is further appreciated that in accordance with such spring biasing, the follower block 12 can only by moved in a direction opposite the holding direction through the application of manual pressure in the direction opposite the holding direction towards the back facing 11″.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A stackable tray apparatus for receiving and holding upright banded stacks of banknotes, comprising:
a base tray defining a tray housing adapted to receive banded stacks of banknotes, wherein said base tray includes a front facing, a back facing, and a two opposing side walls;
a follower block integral with the base tray and configured to hold banded stacks of bank notes against at least one of the front facing and back facing; and
said base tray including an interlocking system operative to secure one base tray that is stacked on top of another base tray.

2. The stackable tray apparatus of claim 1, additionally comprising a front handle extending from the front facing.

3. The stackable tray apparatus of claim 2, additionally comprising a back handle extending from the back facing.

4. The stackable tray apparatus of claim 1, additionally comprising a back handle extending from the back facing.

5. The stackable tray apparatus of claim 1, wherein said follower block is spring loaded.

6. The stackable tray apparatus of claim 1, wherein the interlocking system is defined by said base tray including an interlock that extends down from its bottom surface such that it can wedge between the front facing and back facing of another base tray.

7. A stackable tray apparatus for receiving and holding upright banded stacks of banknotes, comprising:
a base tray defining a tray housing adapted to receive banded stacks of banknotes, wherein said base tray includes a front facing, a back facing, and a two opposing side walls;
said base tray including an interlocking system operative to secure one base tray that is stacked on top of another base tray;
a front handle extending from the front facing; and
a back handle extending from the back facing.

8. The stackable tray apparatus of claim 7, wherein the interlocking system is defined by said base tray including an interlock that extends down from its bottom surface such that it can wedge between the front facing and back facing of another base tray.
